(19) United States
(12) Patent Application Publication
(10) Pub. No.: US 2026/0034019 A1
(43) Pub. Date: Feb. 5, 2026

(54) Back Scratcher with Fingernail Shaped Projections

(71) Applicant: Yale Kadesky, Escondido, CA (US)

(72) Inventor: Yale Kadesky, Escondido, CA (US)

(21) Appl. No.: 19/280,472

(22) Filed: Jul. 25, 2025

Related U.S. Application Data
(60) Provisional application No. 63/676,524, filed on Jul. 29, 2024.

(51) Int. Cl. A61H 7/00

(52) U.S. Cl. CPC A61H 7/004; A61H 2205/081

(57) ABSTRACT

A scratching machine with a scratching belt on a conveyor belt mechanism to rotate the scratching belt, and a cushioned back conforming frame to support the conveyor belt mechanism and maintain optimal contact between the back skin and the scratching belt. The scratching belt uses ridges simulating smooth acrylic finger nails. In an embodiment, the projections can be 3 mm.

### BACKGROUND

A multitude of devices exist to massage and scratch the back. They certainly help relax tense muscles and give pleasure. However, they do not give the pleasure of back scratching.

Scratching the back activates nerve endings that transmit signals to the brain. The brain releases endorphins to these signals which are natural pain killers and mood enhancers.

Scratching can also relieve itchiness, tension and discomfort in skin and muscles.

This combination of physical and chemical responses can create a pleasurable sensation. This explains why scratching your back feels so good.

### SUMMARY OF THE INVENTION

The inventor recognized there were a number of drawbacks to conventional back scratchers. They only scratch a small area at a time for a limited time. People with arthritis in their hands, wrists, elbows, shoulders and neck may find it difficult and painful to use traditional back scratchers.

Therefore, the inventor has devised an automatic back scratcher that scratches the applied area of the back, totally automatically. The device can be scaled to different sizes including small, medium, large and extra-large automatic back scratching units.

### BRIEF DESCRIPTION OF THE DRAWINGS

In the Drawings

The figures show aspects of the invention, and specifically:

FIG. 1 shows a front on view of the back scratcher, showing the scratching surface and a control device for the scratching surface;

FIG. 2 shows a side view of the assembly showing the conveyor belt mechanism used to rotate the scratching belt;

FIG. 3 shows the scratching belt;

FIG. 4 shows the rollers on which the scratching belt is rotated; and

FIG. 5 shows a side view of the scratching belt on the rollers with the scratching surface.

### DETAILED DESCRIPTION

The present application describes an automatic back scratcher that addresses many of the problems of the prior art.

An embodiment describes an automatic back scratcher with a scratching belt.

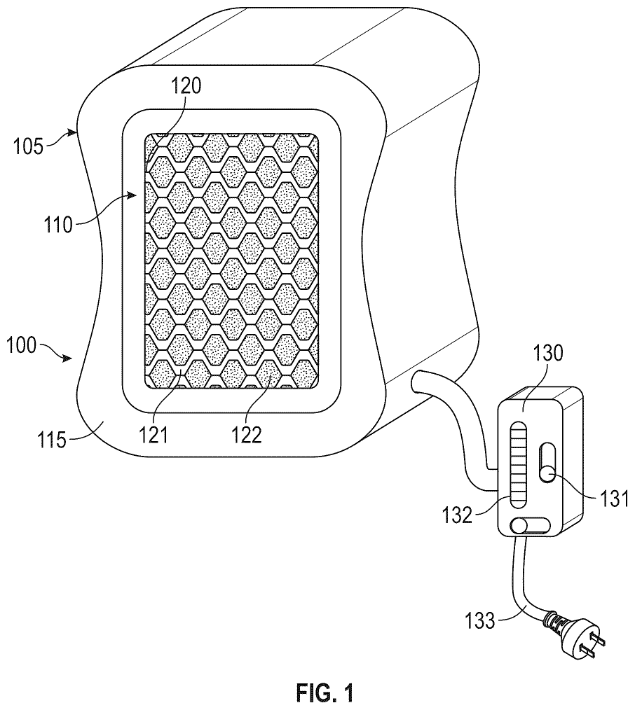

FIG. 1 shows a view of the components of the automatic back scratcher. The scratcher 100 itself includes a housing 105, which defines an opening 110 in its frame front face 115. The opening 110 houses a rotating belt 120, which itself includes a number of ridged front projections, each formed of plastic. The projections 121 are each in the general shape of ridges that alternate with depressions 122. The ridges can be in the shape of smooth acrylic fingernails.

In an embodiment, the projections can be formed of a plastic material such as TPE, and can be made on a 3-D printer or by injection molding.

Projections 121 are approximately 3 mm in length 161 in an embodiment and rounded at the tips 160, to prevent skin injury during scratching.

The rotating belt 120 is mounted on a conveyor belt mechanism as described herein. In embodiments, there are different versions that are sized for small, medium, large and extra-large backs with corresponding sizes for belts and frames.

The frame 115 surrounds the rotating belt 120 with the ridged projections. The frame 115 supports the back and guides how tightly the back can press against the belt. The frame is contoured to the shape of the back and supports the conveyor belt mechanism. Cushioning material is used where the materials could contact the back, and under the belt so that the frame forms a back conforming padded frame.

Control unit 130 provides power for the rotation of the motor. An on/off switch 131 turns the power on and off, and a rheostat 132 is used to regulate the rotational speed of the belt 120 within a safe and comfortable range.

The electrical cord to the conveyor belt machine comes from the control unit. The cord 133 from the control unit plugs into a standard AC electrical outlets.

FIG. 1 shows the back scratcher with back conforming padded frame 115, scratching belt 120, on/off and speed control unit 130, and electrical cord 133.

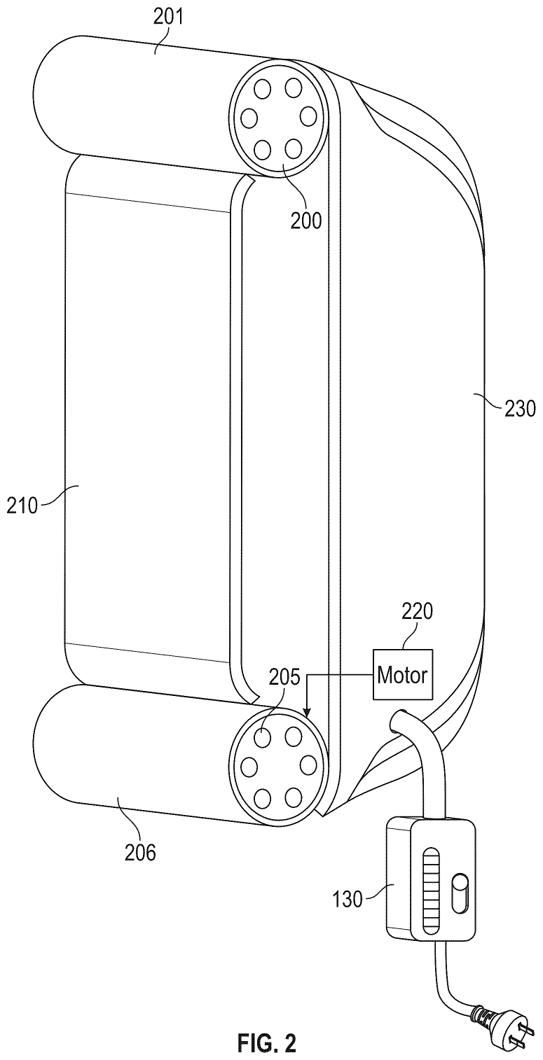

FIG. 2 shows a perspective view of the back scratcher assembly with the scratching belt removed. The scratching belt itself extends between a first roller 200 and a second roller 205.

First roller 200 includes a rolling surface 201, and the second roller 205 includes a rolling surface 206. The belt 120 extends between the first and second rolling surfaces 201, 206, across a flat scratching surface 210 that extends between the rotating surfaces 201, 206. At least one of the rollers is driven by a controllable motor 220 to rotate the belt 120 and thus cause the scratching surface to move between the rollers 201, 206 and cause the scratching effect.

The electrical motor 220 powering the rotating cylinders 201,206 is contained in the unit posterior housing area 230 and under the scratching belt. The electrical cord runs from the control unit 130 to the motor 220 which rotates the scratching belt 120.

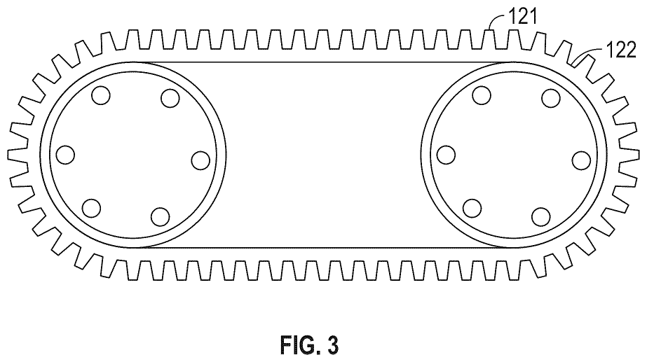

FIG. 3. shows a side view of the scratching belt 120 with 3 mm ridge projections simulating acrylic nails with smooth edges. This belt is made of plastic on a 3-D printer or injection molding.

In operation the scratching belt 120 is extended between the rollers 201, 206.

In an embodiment, the scratching belt may be formed of vinyl with 3 mm ridges alternating with depressions to simulate the feeling of scratching fingernails.

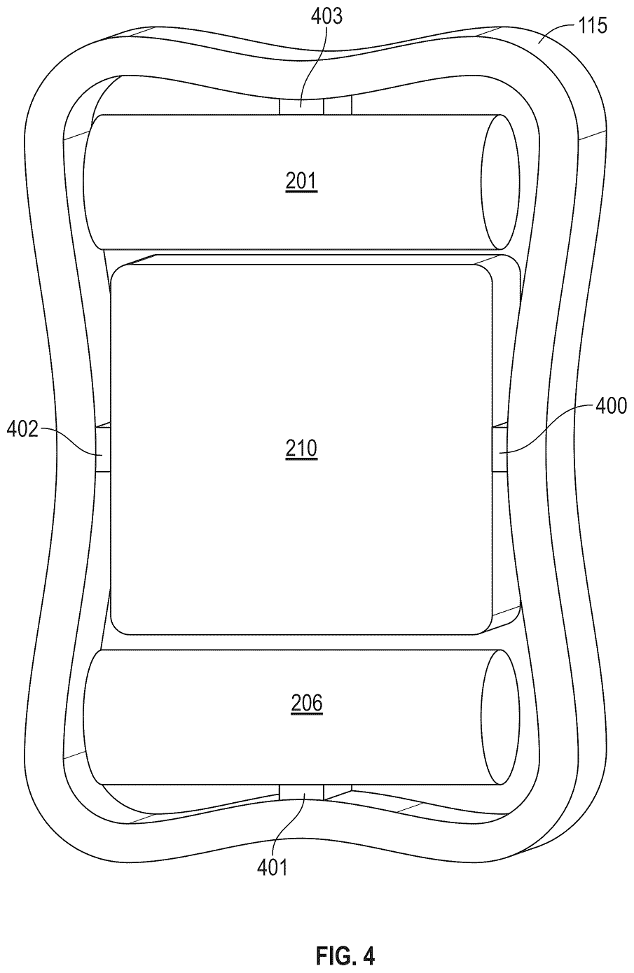

FIG. 4 shows a scratching belt mechanism attached to the cushioned back conforming frame 115 with brackets 400, 401, 402, 403 at top, bottom, left and right sides.

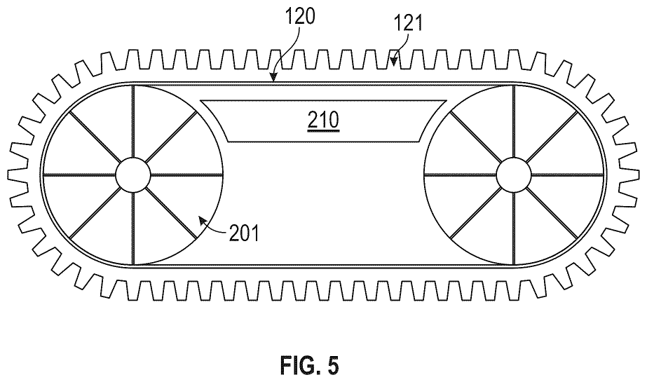

FIG. 5 shows cross sections of scratching belt 120 extending between the surfaces 201, 206 of the conveyor belt rotating cylinders, and extending over the scratching surface 210.

The system forms a rotating scratching belt with ridged projections similar to 3 mm acrylic nails with smooth edges. The belt is designed to fit small, medium, large and extra-large backs. It includes a plastic material with nail-like projections incorporated into the belt material by 3D printing or injection molding. The belts are designed to fit small, medium, large and extra-large conveyor belt mechanisms to rotate the scratching belt. A conveyor belt mechanism is used to rotate the scratching belt.

A flat surface between cylinders supports the back scratcher belt.

In an embodiment, the motor 220 can be driven in a forward direction, where the ridged projections 121 are used to scratch the user's back in a forward. The drive can also be increased or decreased in speed to change the scratching effect.

Both the edges around the frame 115, and the area under the scratching surface that extends between the rollers 201, 206, are formed of a padded material such as an elastomeric. This allows comfort, and also allows a better pressing against the surface of the person's back.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. Backscratching device, comprising:
a scratching belt, having multiple projections simulating the feeling of scratching fingernails;
a housing;
a first roller attached to the housing and rotatable relative to the housing;
a second roller attached to the housing and rotatable relative to the housing;
the scratching belt extending around the first roller and extending around the second roller to rotate when the rollers are rotated; and
a motor, rotating at least one of the rollers, to cause the scratching belt to move in a direction of the rotating rollers and to cause the ridges to move and thus form a backscratching operation.

2. The device as in claim 1, wherein the scratching belt has ridges simulating the feeling of scratching fingernails.

3. The device as in claim 2, wherein the ridges extend above the surface of the scratching belt by 3 mm.

4. The device as in claim 1, further comprising a controller for the motor, which controls the motor to operate at different speeds and in both the forward direction in which the top portion of the fingernail is at the top and a reverse direction where the top portion of the fingernail and forms the scratching surface.

5. The device as in claim 1, further comprising a surface between the first roller and the second roller, and against which the scratching belt is pressed.

6. The device as in claim 5, wherein the surface is formed of an elastomeric material.

7. The device as in claim 6, wherein the housing surrounds the first roller and the second roller, and includes an elastomeric material surrounding the first roller and the second roller, to conform to a shape of a user's back.

8. The device as in claim 1, wherein the housing extends around the rollers, and includes an elastomeric back conforming material, that presses against a user's back.

9. A backscratching device, comprising:
a housing;
a first roller attached to the housing and rotatable relative to the housing;
a second roller attached to the housing and rotatable relative to the housing;
a motor that rotates at least one of the rollers;
a belt; and
a plurality of ridges on the surface of the belt and forming multiple ridges on the surface that are rotated when the belt is rotated along the first and second rollers.

10. The device as in claim 9, wherein the housing surrounds the first roller and the second roller, and includes an elastomeric material surrounding the first roller and the second roller, to conform to a shape of a user's back.

11. The device as in claim 10, further comprising an elastomeric surface between the first roller and the second roller, and where the belt presses against the elastomeric surface.

12. The device as in claim 11, wherein the ridges extend above the surface of the scratching belt by 3 mm.

13. The device as in claim 10, further comprising a controller for the motor, which controls the motor to operate at different speeds.
